(19) United States
(12) Patent Application Publication
(10) Pub. No.: US 2017/0374377 A1
(43) Pub. Date: Dec. 28, 2017

(54) SINGLE-PASS REAL-TIME VIDEO STABILIZATION

(71) Applicant: ATI Technologies ULC, Markham (CA)

(72) Inventor: Earl-Toan Mai, Markham (CA)

(73) Assignee: ATI Technologies ULC, Markham (CA)

(21) Appl. No.: 15/191,914

(22) Filed: Jun. 24, 2016

(51) Int. Cl. H04N 19/51; H04N 19/13; H04N 19/139; H04N 19/172

(52) U.S. Cl. CPC H04N 19/51; H04N 19/172; H04N 19/13; H04N 19/139; H04N 2201/0428

(57) ABSTRACT

A method, processor, and non-transitory computer-readable medium are disclosed for real-time video stabilization and encoding in a single motion estimation pass for each frame. The method includes performing motion estimation on a stabilized current frame and determining a global motion vector using motion estimation information obtained in the performing of motion estimation on the stabilized current frame. A subsequent frame in a video stream is stabilized using this global motion vector. Motion estimation is performed on the stabilized subsequent frame.

### BACKGROUND

Stabilization refers to stabilizing motion in images, whether still images or video (moving) images. An example of video stabilization is removing, or compensating for, apparent motion created by the shaking of a camera, especially a hand-held camera. Video stabilization requires distinguishing between local motion, such as actual motion of an object relative to a background, and global motion, such as apparent motion in an image arising from motion of the camera recording that image. The term motion estimation refers generally to the analysis of image information to estimate motion of any kind. Global motion estimation is a type of motion estimation designed to determine and characterize global motion. One result of global motion estimation may be a global motion vector (GMV) which characterizes only the global motion and is needed for video stabilization. Image compensation may refer to a process of using a GMV to stabilize a video image—that is, to compensate for global motion.

In the past, video stabilization has been performed using mechanical methods or software involving multiple encoding passes for each frame to determine motion needed for stabilization. Some software methods require at least three passes for each frame: object detection, motion detection, and actual encoding. A current stabilization technique requires two passes on a frame to stabilize that frame: a first pass to determine a GMV and a second pass to actually encode the frame. FIG. 2 shows an example of an existing processing apparatus 200 for video stabilization. A reference frame 205 and a current frame 210 are both input to global motion estimator 220, which performs global motion estimation using both input frames, and outputs a global motion vector (GMV) that tends to characterize global motion alone. This particular GMV is labeled GMV_{c} in FIG. 2. This GMV_{c} is combined with current frame 210 at point 255 and the combined information is input to image compensator 225, which outputs a stabilized current frame 230. Stabilized current frame 230 is then encoded by video encoder 245. Video encoder 245 includes motion estimator 240 configured to perform motion estimation on a stabilized current frame 230, and coder 235 configured to perform the actual encoding of the stabilized current frame 230. Encoder 245 outputs bitstream 250 representing an encoded and stabilized frame to be eventually decoded and displayed on a display device.

In the apparatus of FIG. 2, each frame goes through two motion estimation passes: current frame 210 goes first through global motion estimation 220 to determine the GMV_{c} and also through motion estimation 240 as part of encoding 245.

With larger video sizes such as 1080p and 4k, and still larger ones to come, performing such multiple passes for each frame in real time becomes too time-consuming to be feasible, since the processing is slower than real time.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more disclosed implementations may be included;

FIG. 2 is a block diagram of an existing processor configured to stabilize video;

FIG. 3 is a block diagram of an implementation of a processor configured to stabilize video; and

FIG. 4 is a flow chart of an implementation of a method of video stabilization.

### DETAILED DESCRIPTION

A method, processor, and a non-transitory computer-readable medium are disclosed for real-time video stabilization and encoding in a single motion estimation pass for each frame. The method includes performing motion estimation on a stabilized current frame and determining a global motion vector using motion estimation information obtained in performing motion estimation on the stabilized current frame. A subsequent frame in a video stream is stabilized using this GMV or a function of this GMV. The subsequent frame may be the next frame immediately following the current frame. Motion estimation is performed on the stabilized subsequent frame.

In an implementation, determining a GMV may include applying global motion estimation to the motion estimation information. The motion estimation information may include information derived from a plurality of GMV's determined from a plurality of frames preceding the current frame. Stabilizing a subsequent frame using the GMV may include applying image compensation to the subsequent frame using the GMV.

An implementation of the method may include encoding the stabilized current frame and outputting an encoded bitstream for the encoded stabilized current frame. The encoding may include motion estimation and may include entropy encoding. In an implementation of the method, a rate of frame encoding and a rate of frame stabilization may be equal.

In an implementation, a processor may be configured to stabilize and encode a video frame in a single motion estimation pass per frame. The processor may include a video encoder comprising a motion estimator, the motion estimator configured to perform motion estimation on a stabilized current frame; a global motion estimator configured to determine a global motion vector (GMV) using motion estimation information obtained from the motion estimator in the performing of motion estimation; and an image compensator configured to stabilize a subsequent frame using the GMV. The motion estimator may be further configured to perform motion estimation on the stabilized subsequent frame.

The image compensator may be further configured to stabilize the subsequent frame by applying image compensation to the subsequent frame using the GMV. The encoder may be further configured to encode the stabilized current frame and output an encoded bitstream for the encoded stabilized current frame. The encoder may be configured to perform entropy encoding.

The processor may be configured to perform frame encoding and frame stabilization at equal rates.

In an implementation, a non-transitory computer-readable medium may have instructions stored thereon, which, when executed by a computing device, cause the computing device to perform operations including performing motion estimation on a stabilized current frame; determining a global motion vector (GMV) using motion estimation information obtained in the performing of motion estimation on the stabilized current frame; stabilizing a subsequent frame using the GMV; and performing motion estimation on the stabilized subsequent frame.

As video frame rates increase, the method becomes increasingly effective, since changes from one frame to the next frame in a video stream decrease with increasing frame rates. This allows for more reliable and accurate motion analysis and prediction compared to existing methods.

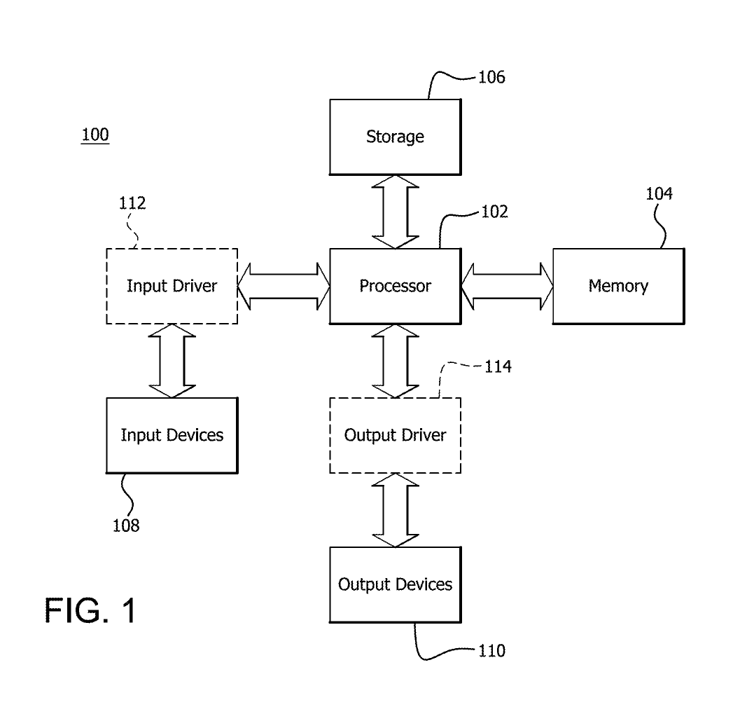

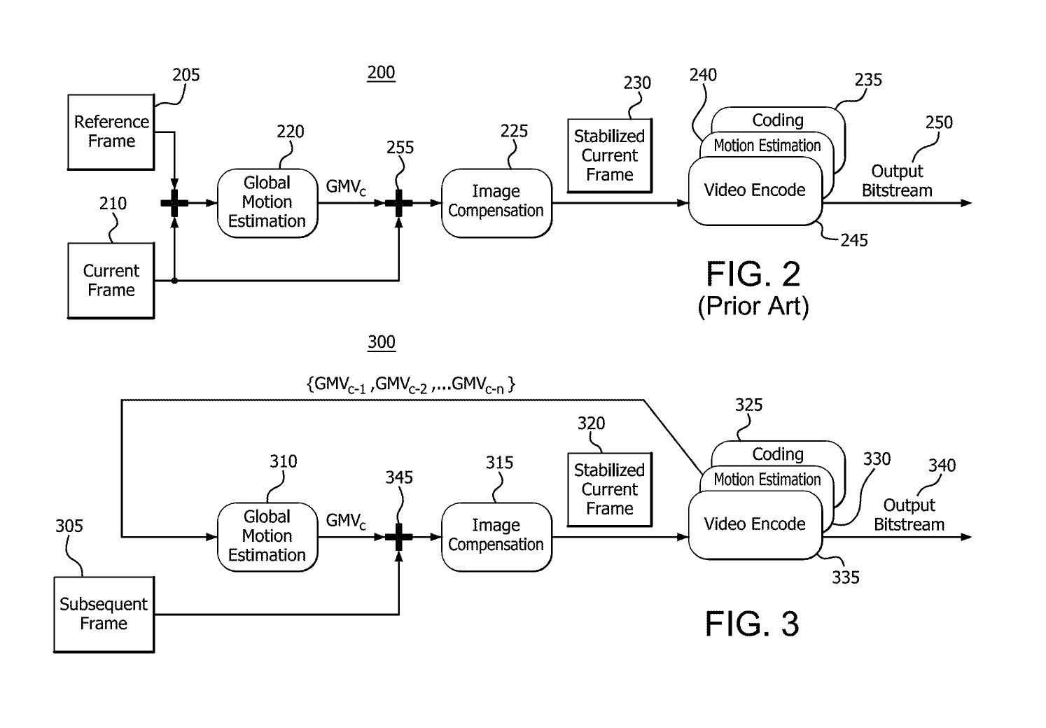

FIG. 1 is a block diagram of an example device 100 in which one or more disclosed implementations may be included. The device 100 may include, for example, a computer, a gaming device, a handheld device, a set-top box, a television, a mobile phone, or a tablet computer. The device 100 includes a processor 102, a memory 104, a storage 106, one or more input devices 108, and one or more output devices 110. In some variations, the device 100 also optionally includes an input driver 112 and/or an output driver 114. It is understood that the device 100 may include additional components not shown in FIG. 1.

The processor 102 includes a central processing unit (CPU), a graphics processing unit (GPU), a CPU and GPU located on the same die, or one or more processor cores, wherein each processor core may be a CPU or a GPU. The memory 104 may be located on the same die as the processor 102, or may be located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include a keyboard, a keypad, a touch screen, a touch pad, a detector, a microphone, an accelerometer, a gyroscope, a biometric scanner, and/or a network connection (e.g., a wireless local area network card for transmission and/or reception of wireless IEEE 802 signals). The output devices 110 include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

FIG. 3 shows an implementation of a processor 300 for video stabilization. Processor 300 may be considered as a block diagram showing structural components of a processor configured to both stabilize and encode a video frame in a single pass. These components include a video encoder 335, a global motion estimator 310, and an image compensator 315. Also shown are a motion estimator 330 and a coder 325. These components may be implemented in hardware, in software, in firmware, or in any combination of hardware, software, or firmware.

Video encoder 335 is configured to encode a stabilized current frame 320. Video encoder 335 may be configured to perform a known encoding method such as entropy encoding. The encoding may include motion estimation carried out by motion estimator 330. Global motion estimator 310 is configured to receive at least a portion of information in the encoded stabilized current frame from video encoder 335 and/or motion estimator 330 and, using the encoded stabilized current frame, determine a GMV. This GMV is combined with a subsequent frame 305 at point 345. Image compensator 305 is configured to receive the combined GMV and subsequent frame and use the GMV and subsequent frame to stabilize the subsequent frame, to produce a new stabilized current frame 320. This new stabilized current frame 320 is received by encoder 335 and encoded, thus completing a cycle. After encoding each frame, encoder 335 outputs each encoded frame as an output bitstream 340, which is eventually displayed. Thus, processor 300 is configured to operate in a cycle to stabilize and encode each frame of a video sequence using a single pass of each frame through motion estimation at motion estimator 330.

Motion estimator 330 is configured to apply motion estimation to the stabilized current frame and convey results of the motion estimation to global motion estimator 310. These results may include information derived from a plurality of GMV's determined from a plurality of frames preceding the stabilized current frame.

Processor 300 may be configured to perform frame encoding and frame stabilization at equal rates. It may be configured to perform synchronized frame encoding and frame stabilization.

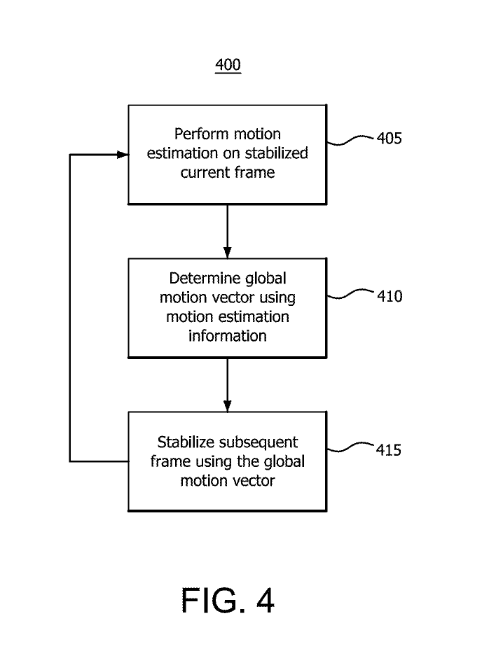

FIG. 4 is a flow chart of an implementation of a method 400 of real-time video stabilization and encoding in a single pass for each frame. A current frame which has been stabilized is encoded 405, resulting in an encoded stabilized current frame. A GMV is determined using the encoded stabilized current frame 410. In one implementation, the next frame, immediately subsequent to the current frame, is stabilized using this GMV 415. Alternatively, any other frame subsequent to the current frame may be stabilized using this GMV 415. This stabilized subsequent frame is now a new stabilized current frame. The method loops back to 405, wherein the stabilized subsequent frame is encoded, and the cycle repeats for each frame in succession.

As described above in reference to FIG. 3, each GMV is determined by applying motion estimation to the encoded stabilized current frame and then applying global motion estimation to results of the motion estimation to produce the GMV. Results of the motion estimation may include a plurality of GMV's determined from a plurality of frames preceding the stabilized current frame. Stabilizing a subsequent frame using a GMV may include applying image compensation to the GMV and to the subsequent frame, which is as yet unstabilized.

Once each frame is stabilized using the method of FIG. 4, it is encoded as an encoded bitstream and outputted. Encoding may be done using a known video encoding standard such as, but not limited to, MPEG1, MPEG 2, MPEG4, H264, HEVC, or VP9. Motion estimation and coding may be carried out in conformity with such standards, and the coding itself may be, but is not limited to, entropy encoding.

The method of FIG. 4 may be executed such that a rate of frame encoding and a rate of frame stabilization (both measured in, for example, frames per second) are equal. Indeed, FIG. 3 suggests that these two rates may not only be made equal but also may be essentially synchronized.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the implementations.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method of real-time video stabilization and encoding in a single motion estimation pass per frame, the method comprising:
performing motion estimation on a stabilized current frame;
determining a global motion vector (GMV) using motion estimation information obtained in the performing of motion estimation on the stabilized current frame;
stabilizing a subsequent frame using the GMV; and
performing motion estimation on the stabilized subsequent frame.

2. The method of claim 1, wherein the subsequent frame is the next frame immediately following the current frame.

3. The method of claim 1, wherein determining a GMV comprises:
applying global motion estimation to the motion estimation information to produce the GMV.

4. The method of claim 1, wherein the motion estimation information comprises information derived from a plurality of GMV's determined from a plurality of frames preceding the current frame.

5. The method of claim 1, wherein stabilizing a subsequent frame using the GMV comprises applying image compensation to the subsequent frame using the GMV.

6. The method of claim 1, further comprising encoding the stabilized current frame and outputting an encoded bitstream for the encoded stabilized current frame.

7. The method of claim 6, wherein the encoding comprises motion estimation.

8. The method of claim 6, wherein the encoding comprises entropy coding.

9. The method of claim 1, wherein a rate of frame encoding and a rate of frame stabilization are equal.

10. A processor configured to stabilize and encode a video frame in a single motion estimation pass per frame, the processor comprising:
a video encoder comprising a motion estimator, the motion estimator configured to perform motion estimation on a stabilized current frame;
a global motion estimator configured to determine a global motion vector (GMV) using motion estimation information obtained from the motion estimator in the performing of motion estimation; and
an image compensator configured to stabilize a subsequent frame using the GMV;
the motion estimator further configured to perform motion estimation on the stabilized subsequent frame.

11. The processor of claim 10, wherein the subsequent frame is the next frame immediately following the current frame.

12. The processor of claim 10, wherein the motion estimation information comprises information derived from a plurality of GMV's determined from a plurality of frames preceding the current frame.

13. The processor of claim 10, wherein the image compensator is further configured to stabilize the subsequent frame by applying image compensation to the subsequent frame using the GMV.

14. The processor of claim 10, wherein the encoder is further configured to encode the stabilized current frame and output an encoded bitstream for the encoded stabilized current frame.

15. The processor of claim 10, wherein the encoder is configured to perform entropy encoding.

16. The processor of claim 10 configured to perform frame encoding and frame stabilization at equal rates.

17. A non-transitory computer-readable medium having instructions stored thereon, which, when executed by a computing device, cause the computing device to perform operations comprising:
performing motion estimation on a stabilized current frame;
determining a global motion vector (GMV) using motion estimation information obtained in the performing of motion estimation on the stabilized current frame;
stabilizing a subsequent frame using the GMV; and
performing motion estimation on the stabilized subsequent frame.
